(19) United States
(12) Patent Application Publication
(10) Pub. No.: US 2007/0054524 A1
(43) Pub. Date: Mar. 8, 2007

(54) Packing module and packing assembly comprising the same

(76) Inventors: Hyun-Ye Lee, Suwon-si (KR); In-Soo Cho, Suwon-si (KR); Tae-Sin Hwang, Suwon-si (KR); Hyuk Kim, Suwon-si (KR); Dong-Hyok Shin, Suwon-si (KR); Ik-Sang Lee, Suwon-si (KR); Sung-Won Bae, Suwon-si (KR); Yeung-Ki Kim, Suwon-si (KR); Gun-Gue Park, Suwon-si (KR); Kwang-Jin Jeong, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/515,324

(22) Filed: Sep. 1, 2006

(30) Foreign Application Priority Data
Sep. 2, 2005 (KR) 10-2005-0081754
Sep. 2, 2005 (KR) 10-2005-0081755

(51) Int. Cl. H01R 13/62

(52) U.S. Cl. 439/157

(57) ABSTRACT

A packing assembly for display modules is disclosed. The packing assembly includes a plurality of display modules and a plurality of packing modules stacked on top of one another, each packing module comprises: a seating unit where at least one display module is seated and a first frame unit that surrounds at least a portion of the display module. According to one embodiment, the packing assembly can reduce transportation costs of the display modules by increasing the stacking rate of the display modules.

### CROSS-REFERENCE TO RELATED PATENT APPLICATION

This application claims the benefit of Korean Patent Application Nos. 10-2005-0081754 and 10-2005-0081755, filed on Sep. 2, 2005, in the Korean Intellectual Property Office, the disclosure of which is incorporated herein in its entirety by reference. This application also relates to U.S. patent application (Attorney Docket Number: SDIYPL. 099AUS) entitled “Packing assembly for display module,” concurrently filed as this application, which is incorporated by reference.

### BACKGROUND OF THE INVENTION

1. Field of the Invention

The present invention relates to a packing module and packing assembly comprising the same.

2. Description of the Related Art

Recently, display devices that use liquid crystal display panels or plasma display panels have received attention due to their excellent characteristics, such as high image quality, super slim shape, light weight, and a wide viewing angle while realizing a large screen size.

The display panels also include circuit units and signal transmitting members such as a tape carrier package (TCP). Hereinafter, a display module denotes a final product in which a display panel, a chassis base that supports the display panel, and driving units are coupled together. Also, in the display module, the circuit units are coupled to the chassis base.

FIG. 1 is a schematic perspective view of a conventional packing assembly for the transportation of plasma display modules.

Referring to FIG. 1, a plurality of plasma display modules 10 are transported in a box shaped container 90 in an upright position. However, when the plasma display modules 10 are vertically positioned, the weight of the plasma display modules 10 is concentrated along sides of the plasma display modules 10. Therefore, the plasma display modules 10 can be easily damaged by vibrations or external shock and can be bent due to their own weight.

To solve this problem, an additional buffer material is disposed in the container 90 between the plasma display modules 10. However, since the buffer material occupies an internal space of the container 90, the number of plasma display modules 10 that can be loaded in the container 90 is reduced. Accordingly, the cost of the buffer material and the reduced number of the plasma display modules 10 in each container 90 increase the transportation cost of the plasma display modules 10.

### SUMMARY OF CERTAIN INVENTIVE ASPECTS

One aspect of the present invention provides a display module packing assembly that can reduce display transportation costs by increasing a loading rate in the packing assembly when a plurality of display modules are transported therein.

Another aspect of the present invention provides a display module packing assembly that can safely transport plasma display modules without damaging them.

Another aspect of the present invention provides a packing module comprising a seating unit where at least one display module is seated, and a first frame unit that surrounds at least a portion of the display module.

The seating unit may comprise protrusions.

A plurality of the protrusions may be formed along the seating unit.

An opening may be formed at least on a portion of the seating unit.

An anti-sliding layer may be formed on a portion of the seating unit contacting the display module.

The anti-sliding layer may be formed of a material comprising silicon.

The anti-sliding layer may be formed of a material comprising rubber.

The first frame unit may comprise a taper part to guide the display module on an inner surface of the first frame unit.

The first frame unit may comprise grabbing grooves to accommodate the display module at least on an inner surface of the first frame unit.

The seating unit and the first frame unit may be integrally formed with each other.

The seating unit and the first frame unit may be formed of different materials from each other.

The first frame unit may have a greater strength than the seating unit.

The packing module may further comprise a second frame unit that surrounds at least a portion of the first frame unit.

The first frame unit and the second frame unit may be integrally formed with each other.

The first frame unit, the second frame unit, and the seating unit may be integrally formed with each other.

The second frame unit may have a greater strength than the first frame unit.

The first frame unit may further comprise a fixing member.

The fixing member may be discontinuously formed on the first frame unit.

The fixing member may have a stripe shape and may be continuously formed on the first frame unit.

The fixing member may contact a chassis of the display module.

In one embodiment, the fixing member contacts a cover plate of the display module.

The fixing member may be formed of the same material as the first frame unit.

The fixing member may be formed in one body with the first frame unit.

Still another aspect of the present invention provides a packing assembly comprising: a plurality of display modules; and a plurality of packing modules stacked on top of one another, each packing module comprises: a seating unit where at least one display module is seated and a first frame unit that surrounds at least a portion of the display module.

A plurality of seating units may be horizontally formed in each of the packing modules.

The display module may be horizontally seated in the seating unit.

In one embodiment, fixing protrusions are formed on a lower part of the seating unit.

The packing assembly may further comprise connection members to fix the packing modules stacked on top of one another.

The connection member may comprise a main body in the shape of a hollow cylinder and a wing part formed around a circumference of the main body.

The packing assembly may further comprise a cover coupled to an upper part of the uppermost packing module.

A portion of the display module corresponding to a non-display region of the display module may contact the seating unit.

The packing assembly may further comprise a second frame unit that surrounds at least a portion of the first frame unit.

The first frame unit may further comprise a fixing member.

Another aspect of the invention provides a packing assembly comprising: a plurality of stacked packing modules configured to receive a plurality of display modules, wherein each packing module comprises: means for receiving at least one plasma display module and means for contacting, extending from the receiving means, at least a portion of the plasma display module.

### BRIEF DESCRIPTION OF THE DRAWINGS

FIG. 1 is a schematic perspective view of a conventional packing assembly for the transportation of plasma display modules.

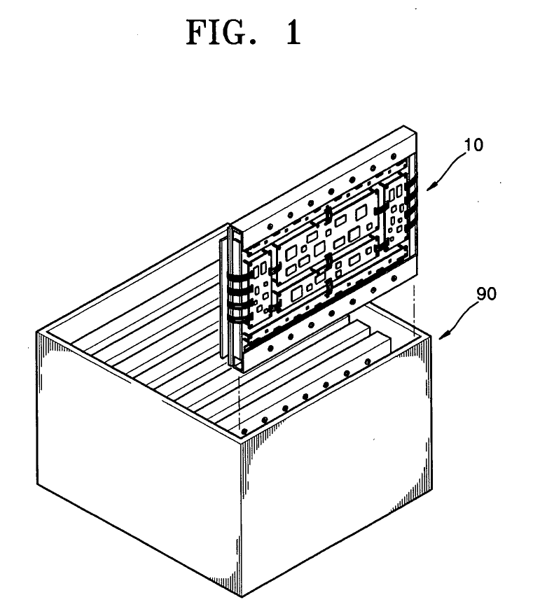

FIG. 2 is a perspective view of a packing module according to an embodiment of the present invention.

FIG. 3 is a cross-sectional view taken along a line III-III of FIG. 2 according to an embodiment of the present invention.

FIG. 4 is a perspective view of a stacked structure of a plurality of the packing modules of FIG. 2.

FIG. 5 is an enlarged perspective view of a connection member depicted in FIG. 4.

FIG. 6 is a cross-sectional view of a packing assembly according to an embodiment of the present invention.

FIG. 7 is a perspective view of a modified version of the packing module illustrated in FIG. 2 according to an embodiment of the present invention.

FIG. 8 is a cross-sectional view taken along a line VIII-VIII of FIG. 7.

### DETAILED DESCRIPTION OF CERTAIN INVENTIVE EMBODIMENTS

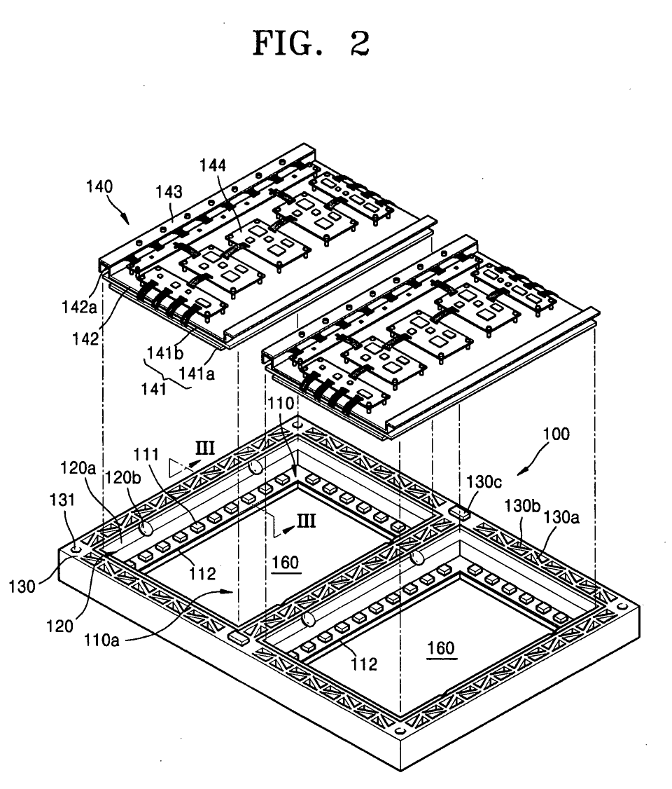

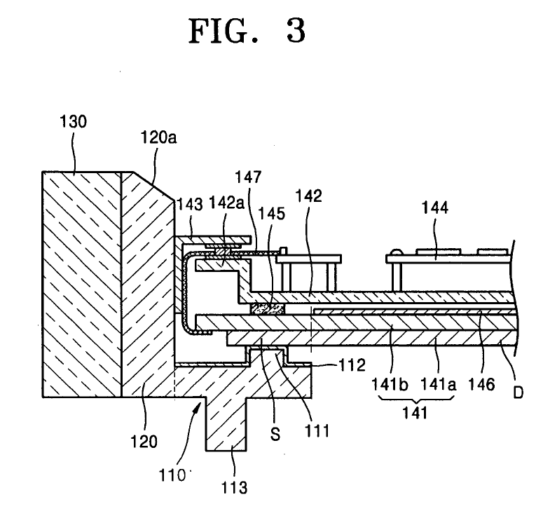

FIGS. 2 and 3 illustrate a packing module 100 according to an embodiment of the present invention.

FIG. 2 is a perspective view of the packing module 100, and FIG. 3 is a cross-sectional view taken along a line III-III of FIG. 2.

In one embodiment, as shown in FIGS. 2 and 3, the packing module 100 includes two seating units 110 (only one seating unit labeled in FIG. 2) each having a first frame unit 120 and a second frame unit 130. In one embodiment, the seating unit 110 may be means for receiving at least one plasma display module, and the first frame unit 120 may be means for contacting, extending from the receiving means, at least a portion of the plasma display module.

Each of a plurality of display modules 140 can be seated in each of the seating units 110. The first frame unit 120 is formed to respectively surround the display module 140 and the seating unit 110. In one embodiment, the first frame unit 120 extends from the seating unit 110 as shown in FIG. 3. In one embodiment, the first frame unit 120 contacts at least a portion of the display module 140.

In one embodiment, the display module 140 is a plasma display module, and includes a plasma display panel 141 comprising a first substrate 141a and a second substrate 141b, a chassis 142 that supports the plasma display panel 141 and includes a chassis bending part 142a on an edge thereof and a cover plate 143 mounted on the chassis bending part 142a. The display module 140 further includes a circuit board 144 that includes circuit devices and is disposed on the chassis 142, a dual adhesive tape 145 (see FIG. 3) that fixes the plasma display panel 141 and the chassis 142, a heat conduction sheet 146 (see FIG. 3) disposed between the plasma display panel 141 and the chassis 142, and signal transmitting members 147 (see FIG. 3) that electrically connect the plasma display panel 141 and the circuit board 144. The signal transmitting members 147 can be flexible printed cables (FPC) or a tape carrier package (TCP).

In the present embodiment, the display module 140 is a plasma display module, but the present invention is not limited thereto. That is, the display modules can be various display modules including a liquid crystal display module.

The display module 140 seated into the packing module 100 has a configuration as described above, but the present invention is not limited thereto. That is, the display module 140 can be one of the following: i) only the plasma display panel 141, ii) a combination of the plasma display panel 141 and the chassis 142, iii) a combination of the plasma display panel 141, the chassis 142, and the circuit board 144 and iv) a complete product that includes the plasma display panel 141. Also, only the chassis 142 or the chassis 142 to which the circuit board 144 is coupled can be seated into the packing module 100.

In one embodiment, the seating unit 110 is horizontally disposed with respect to the packing module 100.

In another embodiment, the seating unit 110 can be disposed at an inclination with respect to the packing module 100.

In one embodiment, the seating unit 110 has an opening 110a in a central portion thereof, and overall, has a closed loop shape. The opening 110a reduces the weight of the seating unit 110 and increases the loading space, thereby allowing better workability.

In one embodiment, the packing module 100 is disposed horizontally, and has two seating units 110 having the same structure. Therefore, two display modules 140 can be accommodated in one packing module 100, but the present invention is not limited thereto. That is, the packing module 100 can include one seating unit 110 or at least three seating units 110 disposed horizontally.

In one embodiment, a plurality of protrusions 111 are discontinuously formed along the seating unit 110. The protrusions 111 allow the display modules 140 to be safely seated in the seating unit 110 and perform as a buffer for preventing the display modules 140 from being damaged by vibrations or shock during transportation. The protrusions 111 may be integrally formed with the seating unit 110. Alternatively, the protrusions 111 may be separately formed and coupled to the seating unit 110.

Also, an anti-sliding layer 112 having a predetermined thickness can be formed on the seating unit 110. The anti-sliding layer 112 prevents the plasma display module 140 from sliding, and can be formed by, for example, coating silicon or a resin of a rubber group on the seating unit 110. The anti-sliding layer 112 can also be formed on the plasma display module 140 where the plasma display module 140 directly contacts the seating unit 110.

In another embodiment, the anti-sliding layer 112 can be formed of any material that can prevent the display module 140 from sliding, for example, a polyurethane resin or an acryl resin, etc.

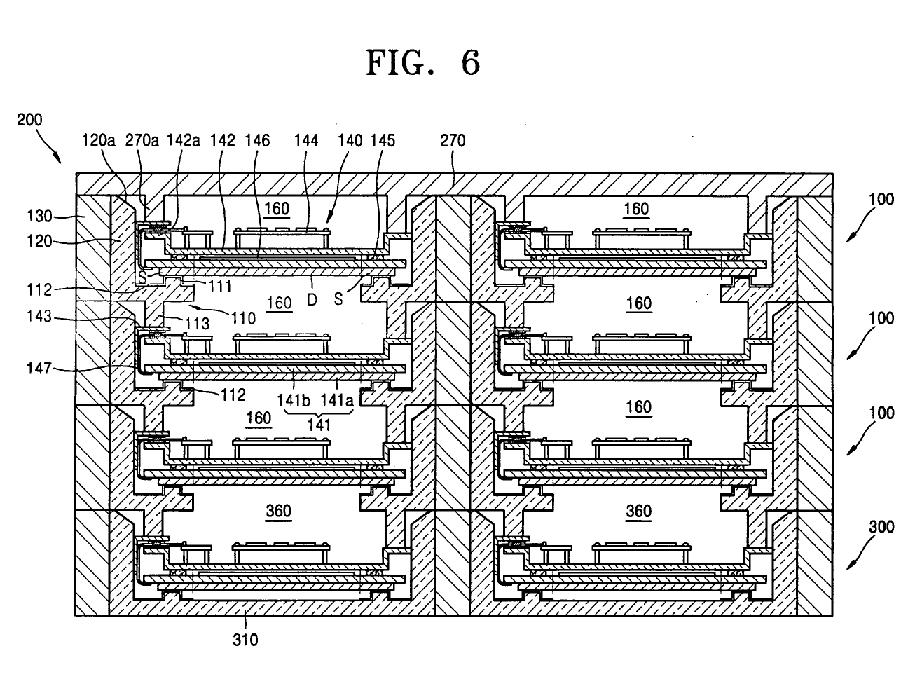

Also, as depicted in FIGS. 3 and 6, a fixing protrusion 113 is formed on a lower part of the seating unit 110. The fixing protrusion 113 fixes the display module 140 seated on a lower packing module 100 when a plurality of the packing modules 100 are stacked (see FIG. 6).

A taper part 120a may be formed on an inner surface of the first frame unit 120.

In one embodiment, the taper part 120a has a downward slope to guide the plasma display module 140 along the taper part 120a for seating the display module 140 in the seating unit 110, thereby improving work efficiency.

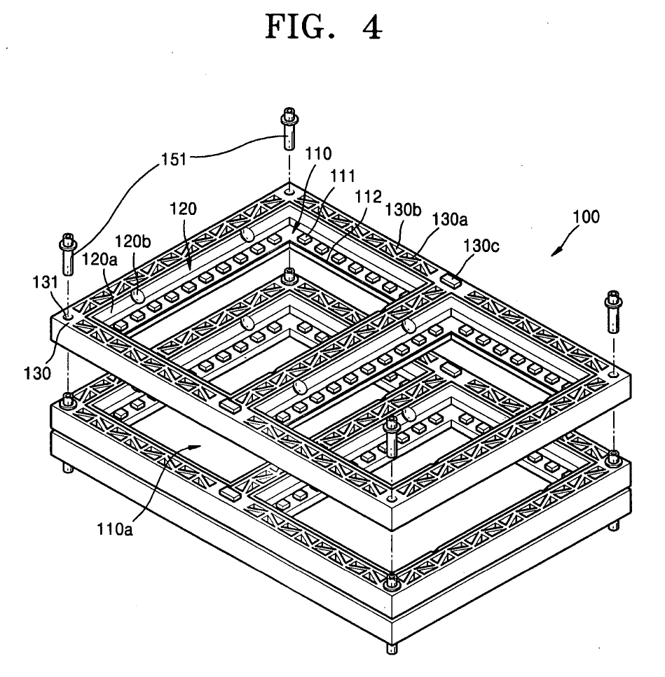

As depicted in FIGS. 2 and 4, the first frame unit 120 includes a plurality of grabbing grooves 120b for easily seating the display modules 140 in the seating unit 110. Accordingly, the display modules 140 can be easily lifted by inserting a hand in the grabbing grooves 120b or can be easily seated in the seating unit 110.

The first frame unit 120 can be formed of the same material as the seating unit 110 and may be integrally formed with the seating unit 110. In one embodiment, the seating unit 110 and the first frame unit 120 can be formed of expanded polypropylene (EPP) with a density of 25 to 35 kg/m³.

In another embodiment, there are no specific limitations in selecting the material for forming the seating unit 110 and the first frame unit 120, and the seating unit 110 and the first frame unit 120 can be formed of different materials from each other. For example, the first frame unit 120 can be formed of EPP and the seating unit 110 can be formed of expanded polyethylene (EPE). Also, the first frame unit 120 may have a greater strength than the seating unit 110.

In one embodiment, the first frame unit 120 and the seating unit 110 are integrally formed with each other. In another embodiment, the first frame unit 120 and the seating unit 110 can be coupled together using an adhesive after they are separately manufactured.

The second frame unit 130 formed to surround the first frame unit 120 can be formed of the same material as the first frame unit 120, but can be formed to have a greater strength by having a higher density than that of the first frame unit 120.

That is, the second frame unit 130 can be formed of EPP having a density of for example, about 60 to about 70 kg/m³ to have strength greater than the first frame unit 120 and the seating unit 110. This is because the second frame unit 130 maintains an overall skeleton of the packing module 100 and prevents damage to the display module 140 from external shocks. In one embodiment, since the seating unit 110 and the first frame unit 120 directly contact or can contact the display module 140, the seating unit 110 and the first frame unit 120 may be formed of a relatively soft material.

In one embodiment, the first frame unit 120 and the second frame unit 130 are separately manufactured, and then coupled together using an adhesive. In another embodiment, the first frame unit 120 and the second frame unit 130 can be integrally formed with each other. In still another embodiment, the three units 110-130 can be integrally formed with each other.

In one embodiment, as shown in FIG. 2, a plurality of ribs 130a and coupling protrusions 130c are formed along the second frame unit 130. The ribs 130a increase the strength of the second frame unit 130.

Also, grooves 130b may be formed between the ribs 130a to reduce the weight of the second frame unit 130.

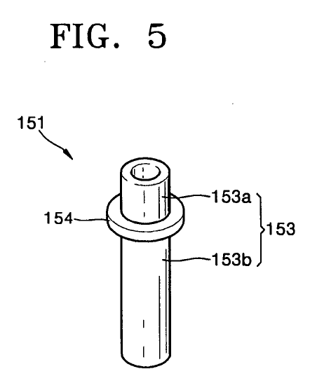

In one embodiment, connection holes 131 that penetrate the second frame unit 130 are formed on corners of the second frame unit 130. Connection members 151 (see FIGS. 4 and 5) are inserted into the connection holes 131 to couple at least two adjacent packing modules 100.

FIG. 4 is an exploded perspective view of a stacked structure of the packing modules 100 of FIG. 2 according to an embodiment of the present invention. In FIG. 4, to show the stacking state of the packing modules 100, the display modules 140 are excluded.

Referring to FIG. 4, the packing modules 100 are stacked on top of one another, and the packing modules 100 are fixed using the connection members 151, which will now be described in detail.

As described above, the second frame unit 130 includes the connection holes 131, and a connection member 151 is inserted into each of the connection holes 131 to connect a plurality of packing modules 100.

FIG. 5 is an enlarged perspective view of the connection member 151 according to an embodiment of the present invention. Referring to FIG. 5, the connection member 151 includes a main body 153, for example, in the shape of a hollow cylinder and a wing part 154 formed around a circumference of the main body 153. The main body 153 is inserted into the connection hole 131 in a fitting state. An upper portion 153a of the main body 153 is inserted into the connection hole 131 of a packing module 100 positioned above, and a lower portion 153b of the main body 153 is inserted into the connection hole 131 of the a packing module 100 positioned below. Therefore, adjacent packing modules 100 can be fixed to each other.

In another embodiment, protrusions 130c are formed on an upper surface of the second frame unit 130, and concave units (not shown) are formed on a lower surface of the second frame unit 130. When the packing modules 100 are stacked, the protrusions 130c of the upper surface of the second frame unit 130 of a packing module 100 positioned below are inserted into the concave units of the lower surface of the second frame unit 130 of a packing module 100 positioned above. Therefore, the connection between the upper and lower packing modules 100 is reinforced.

FIG. 6 is a cross-sectional view of a packing assembly 200 according to an embodiment of the present invention. The same reference numerals will be used for elements described in the previous embodiments.

Referring to FIG. 6, the packing assembly 200 includes a plurality of display modules 140, a plurality of packing modules 100 and 300, and a cover 270.

In one embodiment, the display modules 140 are horizontally loaded in loading spaces 160 and 360 defined by seating units 110 and 310 of each of the packing modules 100 and 300. In one embodiment, a front face of the plasma display panel 141 is seated on the protrusions 111 of the seating unit 110, or on the anti-sliding layer 112. In one embodiment, the first frame unit 120 contacts side surfaces of the chassis 142, the chassis bending part 142a, and the cover plate 143 of the display module 140 so that the display module 140 can be safely seated.

The display modules 140 according to the present embodiment are loaded horizontally with respect to the packing modules 100 and lie horizontally during transportation, but the present invention is not limited thereto. That is, the seating unit 110 of the packing modules 100 may not be horizontally formed. In this case, the display modules 140 are not horizontally loaded with respect to the packing modules 100. Also, even if the display modules 140 are horizontally loaded in the packing modules 100, the display modules 140 can be slanted due to limited space.

A non-display region S of the plasma display panel 141 may be seated on the anti-sliding layer 112 to avoid damaging the plasma display panel 141 or an internal structure thereof, which can be caused when the packing modules 100 and a display region D of the plasma display panel 141 directly contact each other.

In particular, when a film filter (not shown) is attached to the front face of the plasma display panel 141, portions of the film filter corresponding to the non-display region S of the plasma display panel 141 may be seated on the anti-sliding layer 112. When the film filter is attached mainly to the display region D of the plasma display panel 141, the non-display region S of the plasma display panel 141 may be directly seated on the anti-sliding layer 112.

The height of the first frame unit 120 may be such that the first frame unit 120 can accommodate the display module 140 and can prevent the display module 140 moving when the packing assembly 200 is transported.

Also, a plurality of fixing protrusions 113 are discontinuously formed on a lower surface of the seating unit 110. The fixing protrusions 113 are stacked to press the chassis bending part 142a of the display module 140 seated in the packing module 100 positioned below or the cover plate 143. Accordingly, the display modules 140 are reinforced in the packing assembly 200.

Accordingly, the display modules 140 can be loaded without an additional buffer material, thereby increasing the number of display modules 140 that can be loaded in the packing assembly 200. This results in a reduction of packing and transportation costs of the packing assembly 200.

In one embodiment, the seating units 310 of the lowermost packing modules 300 do not have openings 110a to prevent moisture or dust from entering the seating space 360 since the moisture or dust can damage the display modules 140. However, other portions of the packing modules 300 have the same structure as the packing module 100 depicted in FIG. 2, and thus, detailed descriptions thereof are omitted.

In one embodiment, as shown in FIG. 6, a cover 270 is coupled to the uppermost packing modules 100. The cover 270 prevents the display modules 140 from being damaged by moisture or dust infiltrating into the seating space 160. Cover fixing protrusions 270a that perform the same function as the fixing protrusion 113 are formed on an inner surface of the cover 270. The cover 270 may be formed of substantially the same material as the second frame unit 130 of the packing module 100.

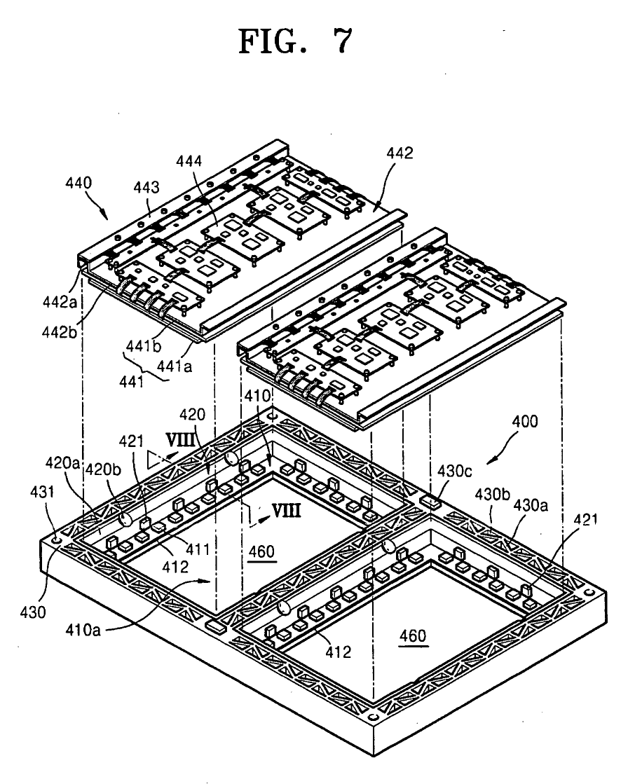

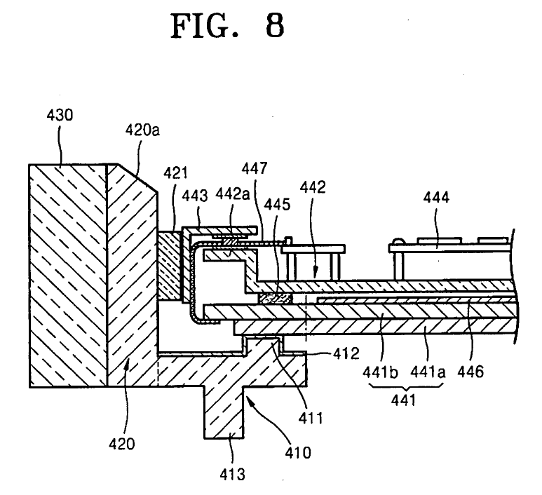

A modified version of the protection member 140 will now be described with reference to FIGS. 7 and 8.

FIG. 7 is an exploded perspective view of a packing module 400 according to an embodiment of the present invention, and FIG. 8 is a cross-sectional view taken along a line VIII-VIII of FIG. 7.

Referring to FIGS. 7 and 8, the packing module 400 includes a seating unit 410, a first frame unit 420, and a second frame unit 430, but the first frame unit 420 additionally includes a fixing member 421 to further safely protect the packing module 400.

In one embodiment, the fixing member 421 is disposed between the first frame unit 420 and display modules 440 to further safely protect the display modules 440 from lateral shock applied to the second frame unit 430 during transportation.

The display module 440 is a plasma display module, and includes a plasma display panel 441 consisting of a first substrate 441a and a second substrate 441b, a chassis 442, a chassis bending part 442a, a cover plate 443, a circuit board 444, a dual adhesive tape 445, a heat conduction sheet 446, and signal transmitting members 447.

In one embodiment, the seating unit 410 includes an opening 410a to increase the volume of the loading space 460, thereby improving workability.

In one embodiment, the seating unit 410 includes protrusions 411, an anti-sliding layer 412, and a fixing protrusion 413, and the first frame unit 420 includes a taper part 420a and a grabbing groove 420b.

In one embodiment, the seating unit 410 and the first frame unit 420 are formed of EPE and are integrally formed with each other.

The second frame unit 430 may be also formed of EPE. After the second frame unit 430 is formed separately from the seating unit 410 and the first frame unit 420, the second frame unit 430 is disposed to surround the first frame unit 420 by contacting the first frame unit 420. The second frame unit 430 includes ribs 430a, grooves 430b, coupling protrusions 430c, and connection holes 431.

In one embodiment, the first frame unit 420 has a protrusion shape and is discontinuously formed along the first frame unit 420.

In one embodiment, the fixing member 421 tightly contacts the chassis bending part 442a of the chassis 442, side surfaces 442b of the chassis 442, and the cover plate 443.

In this embodiment, the fixing member 421 contacts an outermost surface of the display module 440. For example, the fixing member 421 contacts the cover plate 443 on an outer surface of the display module 440 where signal transmitting members 447 for applying signals to address electrodes are mounted and a cover plate 443 is formed. In another embodiment, the fixing member 421 contacts the side surface 442b on an outer surface of the display module 440 where only the chassis bending part 442a is formed. In still another embodiment, the fixing member 421 contacts the side surface 442b of the chassis 442 when the side surface 442b of the chassis 442 forms an outer surface of the display module 440.

In one embodiment, the fixing member 421 has a protrusion shape and is discontinuously formed on the first frame unit 420. In another embodiment, the fixing member 421 can be formed in a stripe shape along the first frame unit 420. In one embodiment, when the signal transmitting members 447 directly crosses the outer surface of the display module 440 that the fixing member 421 contacts, the fixing member 421 may be discontinuously formed since the fixing member 421 contacts the outer surface of the display module 440 without contacting the signal transmitting members 447.

Also, the fixing member 421 may be integrally formed with the first frame unit 420 using the same material as the first frame unit 420. Alternatively, the fixing member 421 can be formed of a different material from the first frame unit 420, and the fixing member 421 can be attached to the first frame unit 420 or can be inserted between the first frame unit 420 and the display module 440 after the fixing member 421 is formed separately from the first frame unit 420.

As described above, the fixing member 421 is formed to tightly contact the chassis bending part 442a of the chassis 442, the side surface 442b of the chassis 442, and the cover plate 443. Therefore, the fixing member 421 protects cables such as a tape carrier package that connects the plasma display panel 441 and circuit boards 444, effectively absorbs shock that are received by the display modules 440, and effectively prevents the shaking of the display modules 440 during transportation.

The configuration, operation, and effects of the packing module 400 according to the present embodiment except for the configuration, operation, and effects described above are identical to the configuration, operation, and effects of the packing module 100 according to the previous embodiment, and thus, descriptions thereof will not be repeated.

A packing assembly can also be formed by stacking the packing modules 400 according to the present embodiment.

In at least one embodiment, the packing module and the packing assembly have the following advantages.

First, the packing assembly has a large seating space since the display modules are loaded without buffer materials. Therefore, a larger number of display modules can be loaded than a conventional packing assembly in a similar-sized packing assembly, thereby reducing packing costs and transportation costs.

Second, since the display modules are safely seated in a packing module and damage to the display modules can further be prevented, the display modules can be further safely protected when the packing assembly is packed or transported.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A packing module comprising:
a seating unit configured to receive at least one display module; and
a first frame unit, connected to the seating unit, which surrounds at least a portion of the display module.

2. The packing module of claim 1, wherein the seating unit comprises at least one protrusion.

3. The packing module of claim 1, wherein the first frame unit contacts at least a portion of the display module.

4. The packing module of claim 1, wherein an opening is formed at least on a portion of the seating unit.

5. The packing module of claim 2, further comprising an anti-sliding layer formed on a portion of the seating unit.

6. The packing module of claim 5, wherein the anti-sliding layer is formed of a material comprising silicon or rubber.

7. The packing module of claim 1, wherein the display module is a plasma display module.

8. The packing module of claim 1, wherein the first frame unit comprises a taper portion configured to guide the display module on an inner surface of the first frame unit.

9. The packing module of claim 1, wherein the first frame unit comprises grabbing grooves configured to accommodate the display module at least on an inner surface of the first frame unit.

10. The packing module of claim 1, wherein the seating unit and the first frame unit form an integral body.

11. The packing module of claim 1, wherein the seating unit and the first frame unit are formed of different materials.

12. The packing module of claim 1, wherein the first frame unit is constructed to be stronger than the seating unit.

13. The packing module of claim 1, further comprising a second frame unit that surrounds at least a portion of the first frame unit.

14. The packing module of claim 13, wherein the first frame unit and the second frame unit form an integral body.

15. The packing module of claim 13, wherein the first frame unit, the second frame unit, and the seating unit form an integral body.

16. The packing module of claim 13, wherein the second frame unit is constructed to be stronger than the first frame unit.

17. The packing module of claim 1, wherein the first frame unit further comprises a fixing member.

18. The packing module of claim 17, wherein the fixing member is discontinuously formed on the first frame unit.

19. The packing module of claim 17, wherein the fixing member has a stripe shape and is continuously formed on the first frame unit.

20. The packing module of claim 17, wherein the fixing member contacts at least a portion of a chassis of the display module.

21. The packing module of claim 17, wherein the fixing member contacts a cover plate of the display module.

22. The packing module of claim 17, wherein the fixing member is formed of the same material as the first frame unit.

23. The packing module of claim 17, wherein the fixing member and the first frame unit form an integral body.

24. A packing assembly comprising:
a plurality of display modules; and
a plurality of packing modules stacked on top of one another, each packing module comprises:
a seating unit configured to receive at least one display module; and
a first frame unit, connected to the seating unit, surrounding at least a portion of the display module.

25. The packing assembly of claim 24, wherein a plurality of seating units are horizontally formed in each of the packing modules.

26. The packing assembly of claim 24, wherein the display module is horizontally seated in the seating unit.

27. The packing assembly of claim 24, wherein fixing protrusions are formed on a lower part of the seating unit.

28. The packing assembly of claim 24, further comprising at least one connection member configured to connect at least two adjacent packing modules.

29. The packing assembly of claim 28, wherein the connection member comprises a main body in the shape of a hollow cylinder and a wing portion formed around a circumference of the main body.

30. The packing assembly of claim 24, further comprising a cover coupled to an upper portion of the uppermost packing module.

31. The packing assembly of claim 24, wherein the seating unit contacts a non-display region of the display module.

32. The packing assembly of claim 24, further comprising a second frame unit that surrounds at least a portion of the first frame unit.

33. The packing assembly of claim 24, wherein the first frame unit further comprises a fixing member.
